(19) United States
(12) Patent Application Publication
(10) Pub. No.: US 2003/0215177 A1
(43) Pub. Date: Nov. 20, 2003

(54) Highly stable compact configurable optical add/drop module

(76) Inventors: Yiqiang Li, San Jose, CA (US); Yongjian Wang, Saratoga, CA (US)

Correspondence Address: SAWYER LAW GROUP LLP, P O BOX 51418, PALO ALTO, CA, 94303, US

(21) Appl. No.: 10/146,521

(22) Filed: May 14, 2002

(51) Int. Cl. G02B 6/293

(52) U.S. Cl. 385/24

(57) ABSTRACT

A method and system for providing an a configurable optical add/drop module is disclosed. The method and system include providing first and second filters and a beam deflector between the filters. The first filter receives an input signal and an add signal, transmits a portion of the input signal to a drop signal, reflects a remaining portion of the input signal to an express channel and transmits the add signal. The second filter reflects the express channel to an output and transmits the drop signal and the add signal. The beam deflector has a first position and a second position. In the first position the beam deflector transmits the drop signal and add signal so the second filter transmits the drop signal to a drop output and the add signal to the output. In the second position the beam deflector deflects the drop signal and the add signal so the second filter transmits the drop signal to the output and decouples the add signal from the output.

### FIELD OF THE INVENTION

The present invention relates to optical systems, and more particularly to a method and system for providing a highly stable configurable optical add/drop module.

### BACKGROUND OF THE INVENTION

Optical communication systems carry optical signals having multiple channels. Each channel is centered around a particular wavelength, which is separated from the central wavelengths of other channels by a particular distance. Configurable optical add/drop modules are used in communication systems to allow one or more channels to be simultaneously added to and dropped from the optical signal. For example, in a communications network, one or more channels may be desired to be dropped at a communications node. At the same communications node other channels may be desired to be added. For an optical signal carrying multiple channels from San Francisco to New York, for example, one or more channels may be desired to be dropped at Chicago. This allows communication to take place between San Francisco and Chicago. Thus, one or more channels are dropped from the optical signal at a communications node at Chicago. In addition, communication may be desired to take place between Chicago and New York. Thus, one or more channels may be added to the optical signal at the communications node at Chicago. For this and other reasons, it is often desirable to add channel(s) to and drop channel(s) from the main optical traffic stream.

FIG. 1 depicts a conventional configurable optical add/drop module 10, which includes a first dense wavelength division multiplexer (“DWDM”) 20, a 2×2 optical switch 30 and a second DWDM 40. The optical signal is input via fiber 12. A portion of the signal is transmitted by the first DWDM 20, while the remainder of the optical signal is reflected as an express channel via fiber 14. The portion of the optical signal transmitted by the first DWDM 20 includes certain channel(s), and may be dropped by the conventional add/drop module 10. Consequently, the portion of the optical signal transmitted by the first DWDM 20 will be termed the drop signal. The drop signal is in the pass band for both the first DWDM 20 and the second DWDM 40. The express channel is provided to the second DWDM 40 via the fiber 14. The express channel is reflected by the second DWDM 40 to the output fiber 44. Thus, the express channel includes portions of the optical signal that are to be output.

The drop signal is transmitted by the first DWDM 20 to the 2×2 switch 30. Depending upon the position of the 2×2 switch 30, the conventional configurable add/drop module 10 can drop the drop signal or retain the drop signal. If the 2×2 switch 30 is in a first, bar state, the drop signal is transmitted directly from the 2×2 switch 30 to the second DWDM 40. The second DWDM 40 transmits the drop channel to the output fiber 44. Consequently, the same signal that is input to the conventional configurable add/drop module 10 via the input fiber 12 is output via the output fiber 44 when the 2×2 switch is in the bar state.

When the 2×2 optical switch 30 is in a cross state, then the drop signal provided from the first DWDM 20 is coupled to the drop fiber 52. At the same time, an add signal provided via the add fiber 50 is transmitted by the 2×2 switch 30 to the second DWDM 40. The add signal is also within the pass band of the DWDM 40. Consequently, when coupled to the DWDM 40 by the 2×2 switch 30, the add signal will also be output via the output fiber 44. The add signal thus replaces the drop signal when the 2×2 switch 30 is in the cross state.

Consequently, the conventional configurable optical add/drop module 10 can be used to either pass an optical signal unchanged or to add and drop one or more channels. However, the conventional configurable add/drop module 10 has several drawbacks. The conventional configurable optical add/drop module 10 is made from a number of components, making it high in cost and bulky. There is also a relatively higher insertion loss for both the add and drop channels because there are more optical coupling paths for both the add and drop signals. In addition, due to the use of the mirror-based 2×2 optical switch 30, the conventional configurable add/drop module 10 also has a lower stability and reliability.

Accordingly, what is needed is an improved system and method for adding channels to and dropping channels from an optical signal. The present invention addresses such a need.

### SUMMARY OF THE INVENTION

The present invention provides a method and system for providing a configurable optical add/drop module. The method and system comprise providing first and second filters and a beam deflector between the filters. The first filter transmits only a first set of wavelengths and receives an input signal and an add signal. The first filter transmits a portion of the input signal to a drop signal, reflects a remaining portion of the input signal to an express channel and transmits the add signal. The second filter transmits only a second set of wavelengths, reflects the express channel to an output, transmits the drop signal to the output or a drop output and transmits the add signal. The beam deflector has a first position and a second position. In the first position the beam deflector deflects the drop signal and add signal so that the second filter transmits the drop signal to a drop output and the add signal to the output. In the second position the beam deflector deflects the drop signal and the add signal so that the second filter transmits the drop signal to the output and decouples the add signal from the output.

According to the system and method disclosed herein, the present invention provides a configurable optical add/drop module is compact, lower insertion loss, highly stable and configurable.

### BRIEF DESCRIPTION OF THE DRAWINGS

FIG. 1 is a diagram of a conventional configurable add/drop module.

FIG. 2 is a diagram of one embodiment of a configurable optical add/drop module in accordance with the present invention.

FIG. 3A is a diagram of one embodiment of a first quadruple fiber pigtail in one embodiment of the configurable optical add/drop module in accordance with the present invention.

FIG. 3B is a diagram of one embodiment of a second quadruple fiber pigtail in one embodiment of the configurable optical add/drop module in accordance with the present invention.

FIG. 4A is a diagram of one embodiment of a narrow band pass filter used in one embodiment of the configurable optical add/drop module in accordance with the present invention.

FIG. 4B is a diagram of one embodiment of the transmission spectrum of the narrow band pass filter used in one embodiment of the configurable optical add/drop module in accordance with the present invention.

FIG. 5A is a side view of one embodiment of the combination of the quadruple fiber pigtail and focal lens in one embodiment of the configurable optical add/drop module in accordance with the present invention.

FIG. 5B is a perspective view of one embodiment of the combination of the quadruple fiber pigtail and focal lens in one embodiment of the configurable optical add/drop module in accordance with the present invention.

FIG. 6A is a side view of one embodiment of the combination of the quadruple fiber pigtail, focal lens and filter in one embodiment of the configurable optical add/drop module in accordance with the present invention.

FIG. 6B is a perspective view of one embodiment of the combination of the quadruple fiber pigtail, focal lens and filter in one embodiment of the configurable optical add/drop module in accordance with the present invention.

FIG. 7 is a side view of one embodiment of the beam deflector used in one embodiment of the configurable optical add/drop module in accordance with the present invention.

FIG. 8 depicts one embodiment of the combination of the filters and beam deflector used in one embodiment of the configurable optical add/drop module in accordance with the present invention.

FIG. 9A is a diagram of the optical path of the express channels in one embodiment of a configurable optical add/drop module in accordance with the present invention while in the add/drop state.

FIG. 9B is a diagram of the optical path of the add/drop signals in one embodiment of a configurable optical add/drop module in accordance with the present invention while in the add/drop state.

FIG. 10A is a diagram of the optical path of the express channels in one embodiment of a configurable optical add/drop module in accordance with the present invention while in the bypass state.

FIG. 10B is a diagram of the optical path of the add/drop signals in one embodiment of a configurable optical add/drop module in accordance with the present invention while in the bypass state.

FIG. 11 depicts one embodiment of a multi-channel configurable optical add drop module in accordance with the present invention.

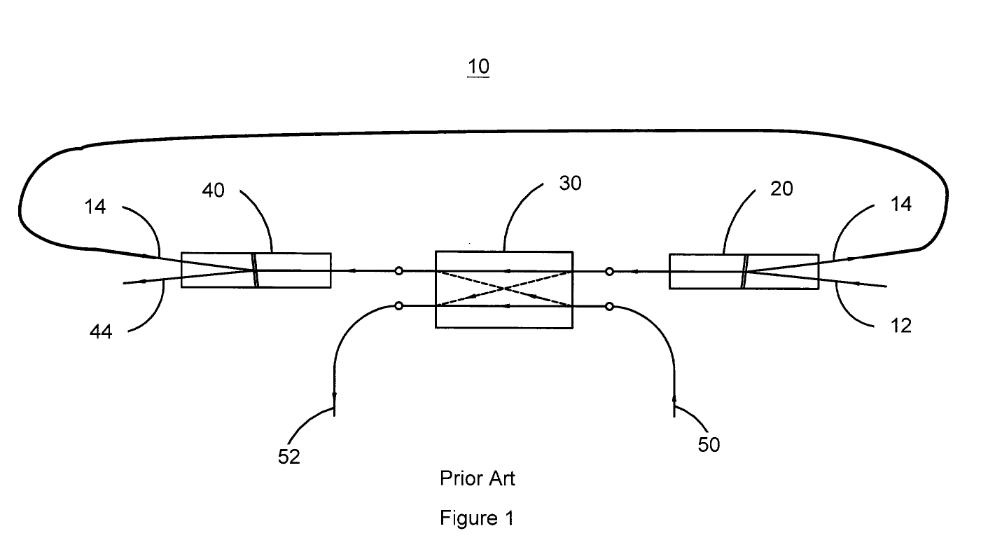

### DETAILED DESCRIPTION OF THE INVENTION

The present invention relates to an improvement in optical systems. The following description is presented to enable one of ordinary skill in the art to make and use the invention and is provided in the context of a patent application and its requirements. Various modifications to the preferred embodiment will be readily apparent to those skilled in the art and the generic principles herein may be applied to other embodiments. Thus, the present invention is not intended to be limited to the embodiment shown, but is to be accorded the widest scope consistent with the principles and features described herein.

The present invention provides a method and system for providing a configurable optical add/drop module. The method and system comprise providing first and second filters and a beam deflector between the filters. The first filter transmits only a first set of wavelengths and receives an input signal and an add signal. The first filter transmits a portion of the input signal to a drop signal, reflects a remaining portion of the input signal to an express channel and transmits the add signal. The second filter transmits only a second set of wavelengths, reflects the express channel to an output, transmits the drop signal to the output or a drop output and transmits the add signal. The beam deflector has a first position and a second position. In the first position the beam deflector deflects the drop signal and add signal so that the second filter transmits the drop signal to a drop output and the add signal to the output. In the second position the beam deflector deflects the drop signal and the add signal so that the second filter transmits the drop signal to the output and decouples the add signal from the output.

The present invention will be described in terms of a particular configurable optical add/drop module having particular components. However, one of ordinary skill in the art will readily recognize that this method and system will operate effectively for other configurable optical add/drop modules having different and/or additional components not inconsistent with the present invention.

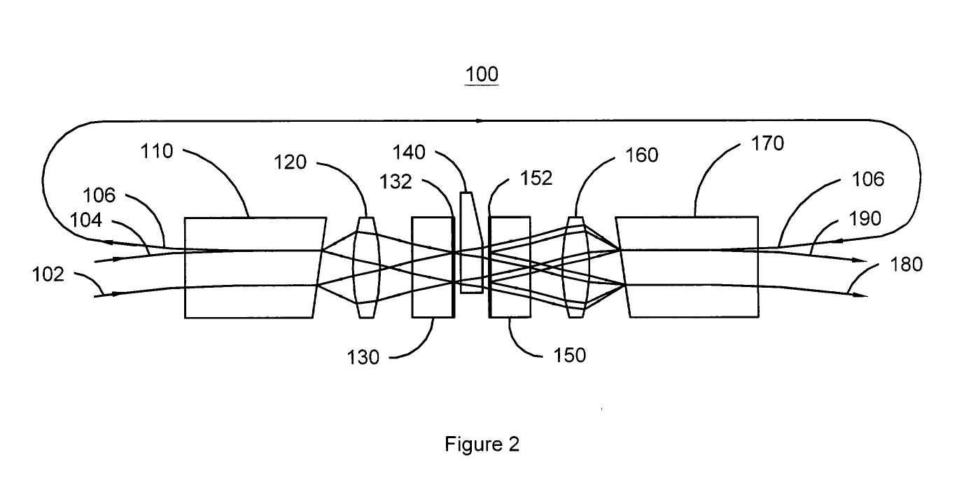

To more particularly illustrate the method and system in accordance with the present invention, refer now to FIG. 2, depicting a preferred embodiment of an a configurable optical add/drop module 100 in accordance with the present invention. The configurable optical add/drop module 100 includes a first quadruple fiber pigtail 110, a first focal lens 120, a first filter 130, a beam deflector 140, a second filter 150, a second focal lens 160 and a second quadruple fiber pigtail 170. The filters 130 and 150 are preferably narrow band pass filters. The filters 130 and 150 also preferably have the same pass band. In addition, each filter 130 and 150 includes a filter coating surface 132 and 152, respectively. The filter coating surfaces 132 and 152 of the filters 130 and 150, respectively, face toward the beam deflector and, therefore, away from the focal lenses 120 and 160, respectively. The configurable optical add/drop module 100 also includes an input fiber 102, an add fiber 104, an express fiber 106 connecting the first triple fiber pigtail 110 with the second triple fiber pigtail 170, a drop fiber 190 and an output fiber 180.

In operation, an optical signal is input to the configurable optical add/drop module 100 via the input fiber 102. The first filter 130 transmits the drop signal and reflects the express channel. The drop signal is the portion of the optical signal including the channel(s) to be dropped. The express channel preferably includes a remaining portion of the optical signal. The express channel is provided to the express fiber 106 and, therefore, transmitted to the second quadruple fiber pigtail 170. The second filter 150 reflects the express channel, which is coupled to the output fiber 180. The drop signal transmitted by the first filter 130 passes through the beam deflector and the second filter 150. Based upon the position of the beam deflector 140, the drop signal is either provided from the second filter to the drop fiber 190 or the output fiber 180. Thus, based upon the position of the beam deflector 140, either the optical signal is transmitted through the configurable optical add/drop module 100 or the drop signal is dropped. In addition, the add signal is input to the add fiber 104 and transmitted by the first filter 130. Based upon the position of the beam deflector 140, the add signal is either provided from the second filter to the output fiber 180 or decoupled from the output fiber 180. Thus, based upon the position of the beam deflector 140, the add signal may be added to the optical signal. The add signal is added to the optical signal when the drop signal is dropped from the optical signal. Similarly, the add signal is not added to the optical signal when the drop signal remains part of the optical signal.

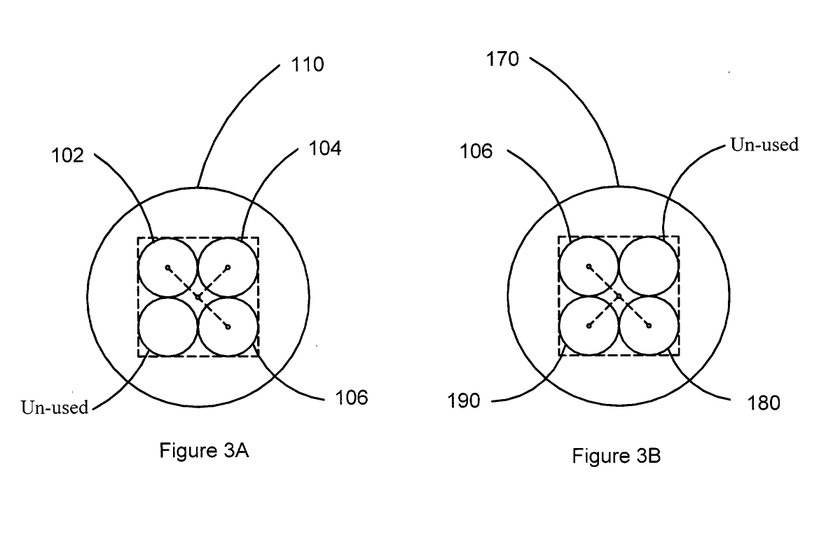

To more particularly describe the configurable optical add/drop module 100 in accordance with the present invention, the individual components are described. FIG. 3A is a diagram of one embodiment of a first quadruple fiber pigtail 110 in one embodiment of the configurable optical add/drop module 100 in accordance with the present invention. FIG. 3B is a diagram of one embodiment of a second quadruple fiber pigtail 170 in one embodiment of the configurable optical add/drop module 100 in accordance with the present invention. Each of the triple fiber pigtails 110 and 170 includes space for four fibers. However, only three of the four fibers are actively used. The fourth fiber is used as a mechanical spacer. As a result, each of the three fibers 102, 104 and 106 and the three fibers 170, 180 and 190 is equidistant from the center of the quadruple fiber pigtail 110 and 170, respectively. In an alternate embodiment, a quadruple fiber pigtail 110 and 170 need not be used. However, a quadruple fiber pigtail is used because it simpler to ensure that the three fibers in each of the quadruple fiber pigtails 110 and 170 are equidistant from the center.

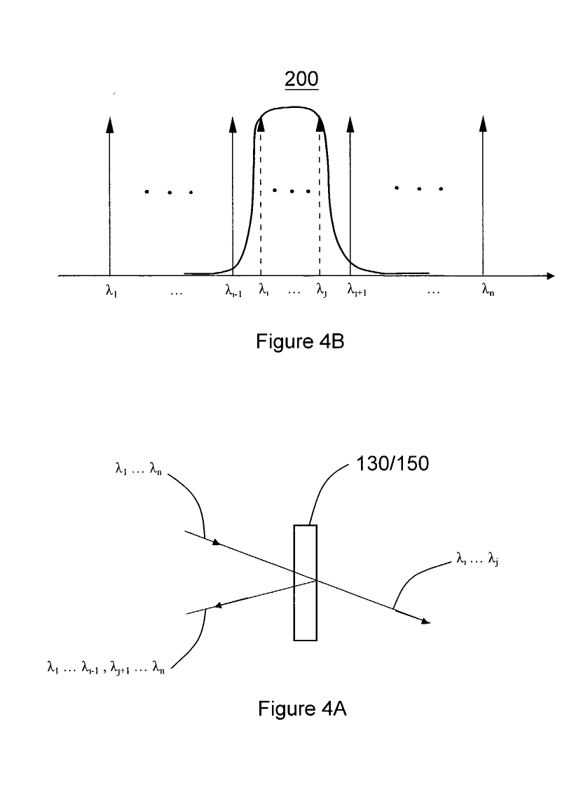

FIG. 4A is a diagram of one embodiment of a narrow band pass filter 130 or 150 used in one embodiment of the configurable optical add/drop module in accordance with the present invention. FIG. 4B is a diagram of one embodiment of the transmission spectrum 200 of the narrow band pass filter 130/150 used in one embodiment of the configurable optical add/drop module in accordance with the present invention. Referring to FIGS. 4A and 4B, the narrow band pass filters 130/150 accepts an input signal with wavelengths λₗ through λₙ, transmits wavelengths λᵢ through λⱼ and reflects λₗ through λᵢ₊₁ and λᵢ₊₁ through λₙ. Thus, the narrow band pass filters 130 or 150 can transmit one or more channels of the optical signal, while reflecting the remainder of the optical signal. For most applications, only a single channel is required to pass through the narrow band pass filter 130 and 150. A typical narrow band pass filter used for a 100 GHz DWDM has a 0.25 nm pass bandwidth, a 0.5 dB pass band insertion loss and a 25 dB adjacent channel isolation.

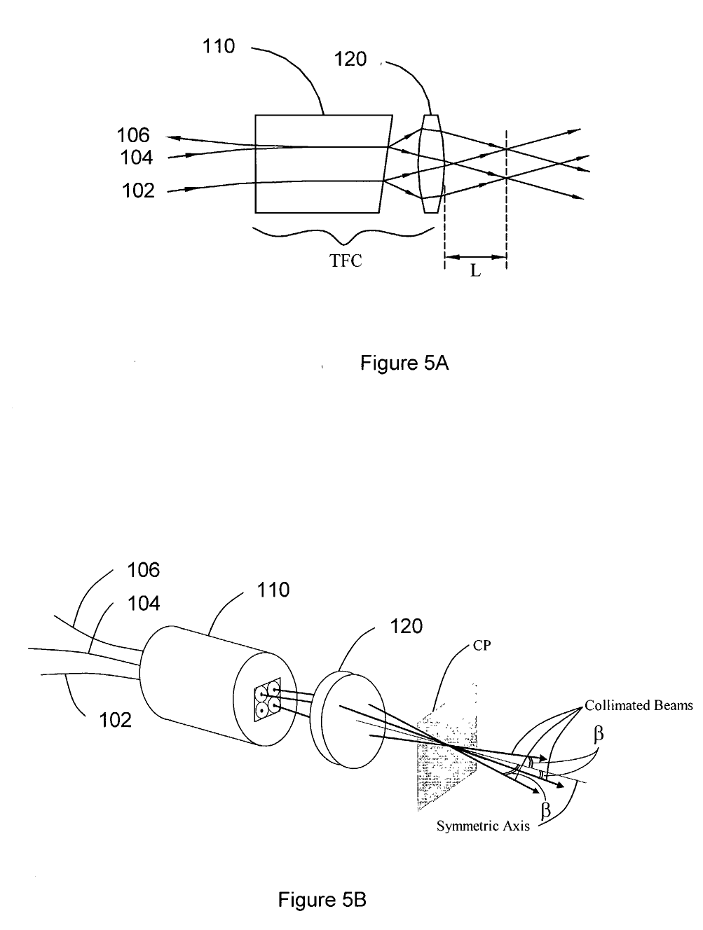

FIG. 5A is a side view of one embodiment of the combination of the quadruple fiber pigtail 110 and focal lens 120 in one embodiment of the configurable optical add/drop module 100 in accordance with the present invention. FIG. 5B is a perspective view of one embodiment of the combination of the quadruple fiber pigtail 110 and focal lens 120 in one embodiment of the configurable optical add/drop module 100 in accordance with the present invention. Referring to FIGS. 5A and 5B, the focal lens 120 is preferably either a conventional spherical or aspherical lens or, in a preferred embodiment, a cylindrical shaped C-lens, which is manufactured by CASIX, Inc., Fuzhou, P.R.China. As shown in FIGS. 5A and B, the focal lens 120 is placed in front of the quadruple fiber pigtail 110 at an optimized distance. Therefore, the optical signals from the input fiber 102, the add fiber 104 and the express fiber 106 are collimated and cross at the cross plane. The cross plane is a distance, L, from the back of the focal lens 120. This crossing distance is typically approximately two to three millimeters. Because the fibers 102, 104 and 106 are equidistant from the center of the quadruple fiber pigtail 1 10, the three collimated beams are tilted from the access of symmetry of the focal lens by the same angle, β, of about 1°-2°, as shown in FIG. 5B. The quadruple fiber pigtail 170 and focal lens 160 are similarly aligned.

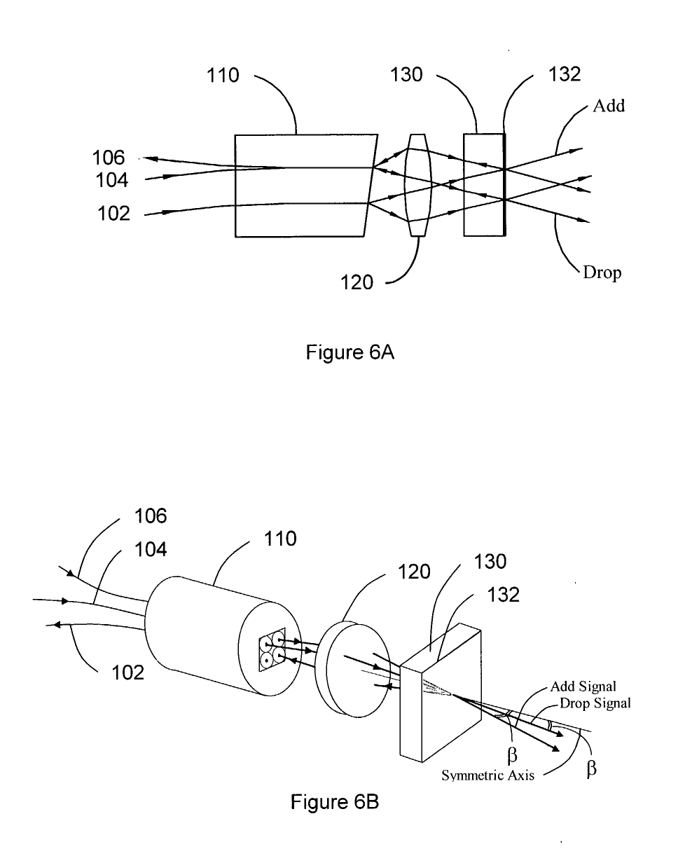

FIG. 6A is a side view of one embodiment of the combination of the quadruple fiber pigtail 110, focal lens 120 and filter 130 in one embodiment of the configurable optical add/drop module 100 in accordance with the present invention. FIG. 6B is a perspective view of one embodiment of the combination of the quadruple fiber pigtail 110, focal lens 120 and filter 130 in one embodiment of the configurable optical add/drop module 100 in accordance with the present invention. The combination of the quadruple fiber pigtail 110, focal lens 120 and filter 130 is defined as a Optical Add/Drop Unit (OADU). Referring to FIGS. 6A and 6B, the quadruple fiber pigtail 110, focal lens 120 and filter 130 are aligned so that the cross plane coincides with the filter coating surface 132. In order to ensure that the cross plane coincides with the coating surface 132, the crossing distance, L, should be greater than the thickness of the filter divided by the index of refraction of the filter. The second quadruple fiber pigtail 170, the second focal lens 160 and the second filter 150 are similarly aligned. The filter 130 is also aligned so that the portion of the optical signal input from the input fiber 102 that is outside of the pass band of the filter 130 is reflected back to the express fiber 106. Since the fibers 102, 104 and 106 are equidistant from the center of the quadruple fiber pigtail 110, the angles of incidence for the optical signal from the input fiber 102 and the add signal from the add fiber 104 are the same. Consequently, the portion of the optical signal input from the fiber 102 that is in the pass band (the drop signal) of the filter 130 and the portion of the add signal that is in the pass band are both transmitted by the filter 130.

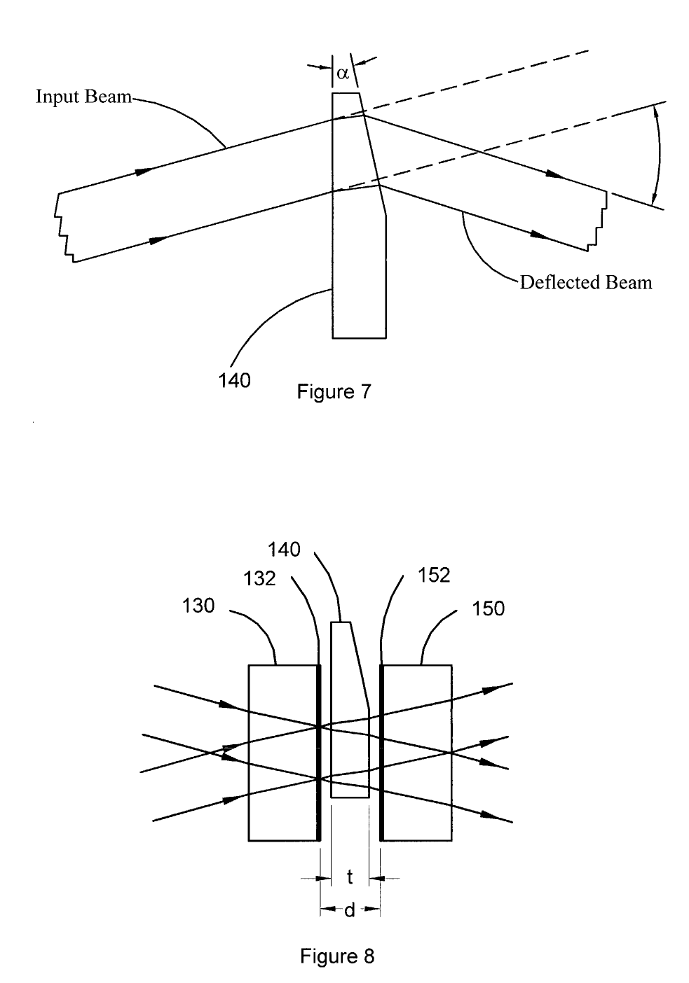

FIG. 7 is a side view of one embodiment of the beam deflector 140 used in one embodiment of the configurable optical add/drop module in accordance with the present invention. A portion of the beam deflector 140 has parallel sides. In another portion of the beam deflector 140, the sides are at an angle, α. This portion of the beam deflector 140 will be termed the wedge portion of the beam deflector 140. In a preferred embodiment, the beam deflector 140 is made of glass, preferably BK7, manufactured by Schott Glass Ltd. The beam deflector 140 also preferably includes an antireflective coating on its front and back surfaces. In a preferred embodiment, the angle, α, of the beam deflector and the angle, β, which the add and drop signals make with the central axis of the filter 130 satisfy the following relationship:

β=(½)sin⁻¹(n sin α)−α/2

where n=refractive index of the beam deflector.

FIG. 8 depicts one embodiment of the combination of the filters 130 and 150 and beam deflector 140 used in one embodiment of the configurable optical add/drop module 100 in accordance with the present invention. The distance between the filter coating surfaces 132 and 152, d, and the thickness of the beam deflector 140, t, are shown. In general, the insertion losses for both the add signal and the drop signal are not minimized simultaneously. However, the insertion losses can be optimized with an excess loss. The excess loss introduced by the gap between the filters 130 and 150 is determined by their effective separation, d_{eff}, which is given by:

d_{eff}=d−(n−1)t/n,

where n is the index of refraction of the beam deflector.

Typical values are 0.7 mm for d, 0.5 mm for t, and 1.5 for n. Thus, the effective separation is on the order of 0.5 mm. Such an effective separation introduces approximately 0.1 dB of excess loss for both add and drop signals. Thus, the impact on the insertion loss for the configurable optical add/drop module 100 due to the separation between filters 130 and 150 is very small.

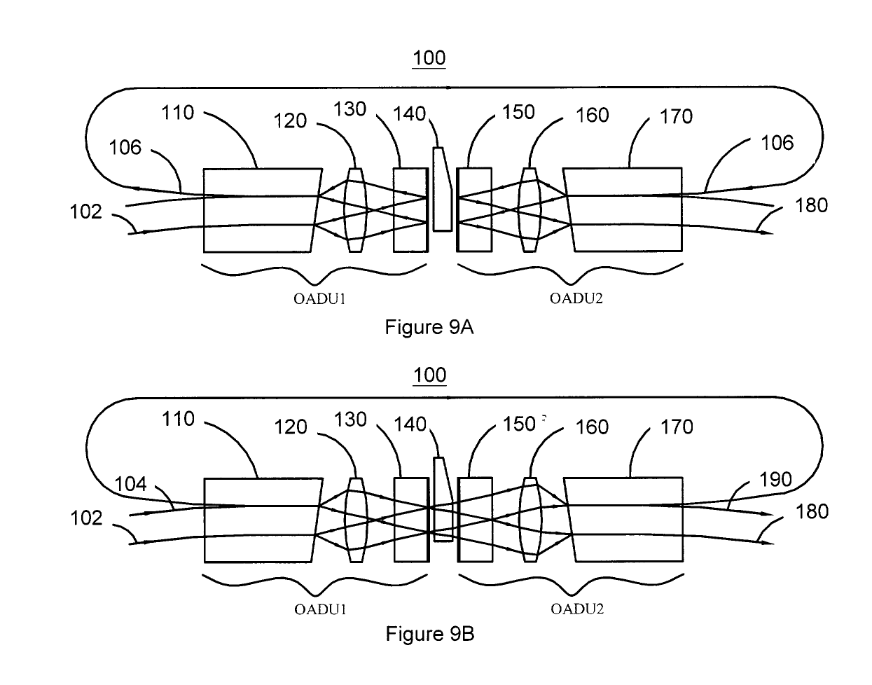

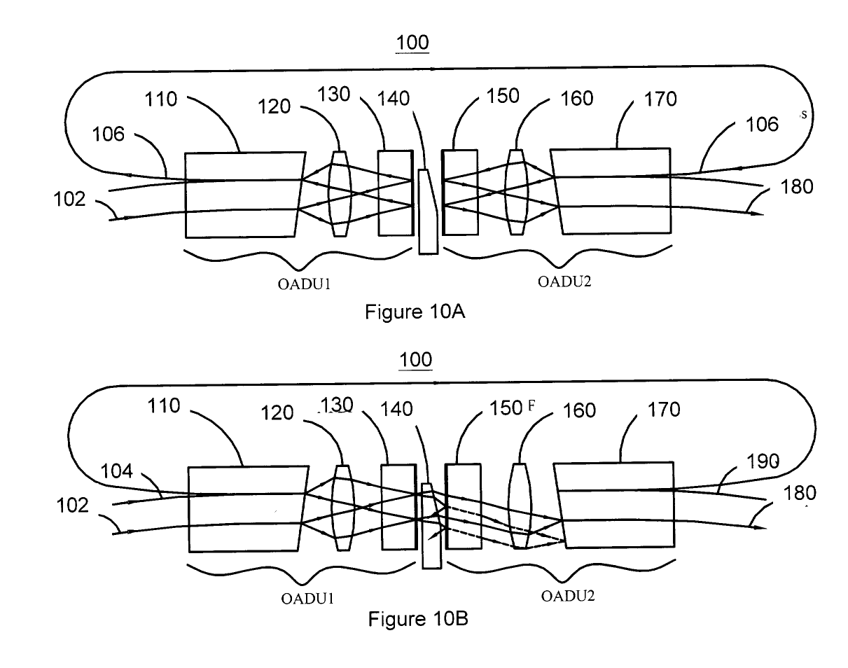

FIGS. 9A, 9B, 10A and 10B aid in describing the operation of one embodiment of the configurable optical add/drop module 100 in accordance with the present invention. FIG. 9A is a diagram of the optical path of the express channels in one embodiment of a configurable optical add/drop module 100 in accordance with the present invention while in the add/drop state. FIG. 9B is a diagram of the optical path of the add/drop signals in one embodiment of the configurable optical add/drop module 100 in accordance with the present invention while in the add/drop state. Thus, when the configurable optical add/drop module 100 is in the configuration depicted in FIGS. 9A and 9B, the drop signal will be dropped from the optical signal input to the configurable optical add/drop module 100 via the input fiber 102 and the add signal input via the fiber 104 will be added to the optical signal.

Referring to FIG. 9A, the optical signal is input via the input fiber 102 and collimated by the combination of the first quadruple fiber pigtail 110 and the first lens 120. The optical signal crosses at the filter coating surface 132. The express channel, the portion of the optical signal outside of the pass band for the filter 130, is reflected by the filter coating surface 132. The express channel is then provided to the express fiber 106. The express fiber 106 transmits the express channel to the second quadruple fiber pigtail 170. The express channel is collimated by the combination of the second quadruple fiber pigtail 170 and the second lens 160. The express channel is reflected from the filter coating surface 152 of the second filter 150 and output via the output fiber 180. Thus, the portion of the optical signal input to the configurable optical add/drop module 100 outside of the pass band of the filters 130 and 150 is output via the output fiber 180. Note that the first quadruple fiber pigtail 110, the first lens 120 and the first filter 130 can be considered to be a first optical add/drop unit (OADU1). Similarly, the second quadruple fiber pigtail 170, the second lens 160 and the second filter 150 can be considered to be a second optical add/drop unit (OADU2). The beam deflector 140 is between the first and second optical add/drop units.

In transmitting the express channel, the configurable optical add/drop module 100 does have an insertion loss. The insertion loss is the sum of the insertion losses between the input fiber 102 and express fiber 106 (including the transmission by the first lens 120 and reflection by the first filter 130) and the insertion loss between the express fiber 106 and the output fiber 180 (including the transmission by the second lens 160 and reflection by the second filter 150). A typical insertion loss for the express channel is approximately 0.6 to 1.0 dB.

Referring back to FIG. 9B, the optical signal is input via the input fiber 102 and collimated by the combination of the first quadruple fiber pigtail 110 and the first lens 120. The optical signal crosses at the filter coating surface 132. The drop signal, which lies within the pass band of the first filter 130, is transmitted by the first filter 130. The beam deflector 140 is in a first position, with its parallel sides in the optical path of the drop signal. As a result, the drop signal is un-deflected by the beam deflector 140, and transmitted by the second filter 150 and provided by the second lens 160 and quadruple fiber pigtail 170 to the drop fiber 190. Thus, the drop signal is dropped from the optical signal. Similarly, the add signal is provided via the add fiber 104 and collimated by the combination of the first quadruple fiber pigtail 110 and the first lens 120. The add signal crosses at the filter coating surface 132. The add signal, which lies within the pass band of the first filter 130, is un-deflected by the beam deflector 140, and transmitted by the first filter 130. The beam deflector 140 is in a first position, with its parallel sides in the optical path of the add signal. As a result, the add signal is transmitted by the second filter 150 and provided by the second lens 160 and quadruple fiber pigtail 170 to the output fiber 180. Thus, the add signal is added to the optical signal at the output of the configurable optical add/drop module 100. Consequently, in the add/drop configuration, with the beam deflector 140 in a first position, the add signal is added to the optical signal, and the drop signal is dropped from the optical signal.

The add and drop signals also experience some insertion loss in traversing the configurable optical add/drop module 100. The insertion loss is mainly determined by the loss between the input fiber 102 and the drop fiber 190 and between the add fiber 104 and the output fiber 180. This insertion loss is the sum of the intrinsic insertion loss of the add or drop signal and the excess loss due to the region between the filters 130 and 150 (i.e. the beam deflector 140 and the spaces between the beam deflector 140 and the filters 130 and 150). The intrinsic insertion loss of the add or drop signal is on the order of 1 dB, while the excess loss, as discussed previously, is on the order of 0.1 dB.

FIG. 10A is a diagram of the optical path of the express channels in one embodiment of a configurable optical add/drop module 100 in accordance with the present invention while in the bypass state. FIG. 10B is a diagram of the optical path of the add/drop signals in one embodiment of a configurable optical add/drop module 100 in accordance with the present invention while in the bypass state. Thus, when the configurable optical add/drop module 100 is in the configuration depicted in FIGS. 10A and 10B, the drop signal remain part the optical signal input to the configurable optical add/drop module 100 via the input fiber 102 and the add signal input via the fiber 104 will not be added to the optical signal. Thus, the add/drop module is considered to be in a bypass state.

Referring to FIG. 10A, the optical signal is input via the input fiber 102 and collimated by the combination of the first quadruple fiber pigtail 110 and the first lens 120. The optical signal crosses at the filter coating surface 132. The express channel, the portion of the optical signal outside of the pass band for the filter 130, is reflected by the filter coating surface 132. The express channel is then provided to the express fiber 106. The express fiber 106 transmits the express channel to the second quadruple fiber pigtail 170. The express channel is collimated by the combination of the second quadruple fiber pigtail 170 and the second lens 160. The express channel is reflected from the filter coating surface 152 of the second filter 150 and output via the output fiber 180. Thus, the portion of the optical signal input to the configurable optical add/drop module 100 outside of the pass band of the filters 130 and 150 is output via the output fiber 180. Thus, the path of the express channel is substantially the same in the bypass state as in the add/drop state. The insertion loss for the express channel is, therefore, approximately the same in the bypass state as for the add/drop state. Thus, typically insertion loss for the express channel is approximately 0.6 to 1.0 dB.

Referring back to FIG. 10B, the optical signal is input via the input fiber 102 and collimated by the combination of the first quadruple fiber pigtail 110 and the first lens 120. The optical signal crosses at the filter coating surface 132. The drop signal, which lies within the pass band of the first filter 130, is transmitted by the first filter 130. The beam deflector 140 is in a second position, with its wedge portion in the optical path of the drop signal. As a result, the drop signal is deflected by the beam deflector 140, transmitted by the second filter 150, and provided by the second lens 160 and quadruple fiber pigtail 170 to the output fiber 180. Thus, the drop signal remains part of the optical signal.

Similarly, the add signal is provided via the add fiber 104 and collimated by the combination of the first quadruple fiber pigtail 110 and the first lens 120. The add signal crosses at the filter coating surface 132. The add signal, which lies within the pass band of the first filter 130, is transmitted by the first filter 130. The beam deflector 140 is in the second position, with its wedge portion in the optical path of the add signal. As a result, the add signal is deflected by the beam deflector 140. The angle of incidence between the add signal and the second filter 150 is thus changed from β to 2β. A portion of the add signal is, therefore, reflected by the second filter 150. A remaining portion of the add signal is transmitted by the second filter 150, but is not coupled to any fiber by second lens 160 and quadruple fiber pigtail 170. Thus, the add signal is decoupled from the optical signal. Consequently, in the bypass state, with the beam deflector 140 in the second position, the drop signal remains part of the optical signal, and the add signal is decoupled from the optical signal. Because it follows approximately the same path through the configurable optical add/drop module, the drop signals experiences approximately the same insertion loss as in the add/drop state. This insertion loss, as discussed previously, is the sum of intrinsic insertion loss, which is on the order of 1 dB, and the excess loss, which is on the order of 0.1 dB.

Thus, the configurable optical add/drop module 100 allows one or more channels to be simultaneously added and dropped. Because the configurable optical add/drop module 100 uses fewer components, it has lower insertion loss and lower cost. Furthermore, a beam deflector 140 is used. The beam deflector 140 requires significantly less precise angular alignment, approximately two hundred times less, than the mirror-type optical switch used in a conventional add/drop module. For example, a ±1° angular misalignment of the beam deflector 140 results in less than a 0.01 degree misalignment of the deflected beam. Thus, the increase in the insertion loss is negligible for such a small misalignment. Consequently, the configurable optical add/drop module 100, due to the use of beam deflector, has a much better mechanical stability and reliability. Because the beam deflector 140 does not require a very precise alignment, the assembly process of the configurable optical add/drop module 100 is simpler and easier. In addition, the highly integrated configuration of the configurable optical add/drop module 100 results in a much smaller package. The use of fewer optical components and the use of low cost focal lenses, such as C-lenses, for the lenses 120 and 160 also make the configurable optical add/drop module 100 less expensive. Consequently, the configurable optical add/drop module 100 has a better mechanical stability, a smaller package dimension, lower insertion loss and lower cost.

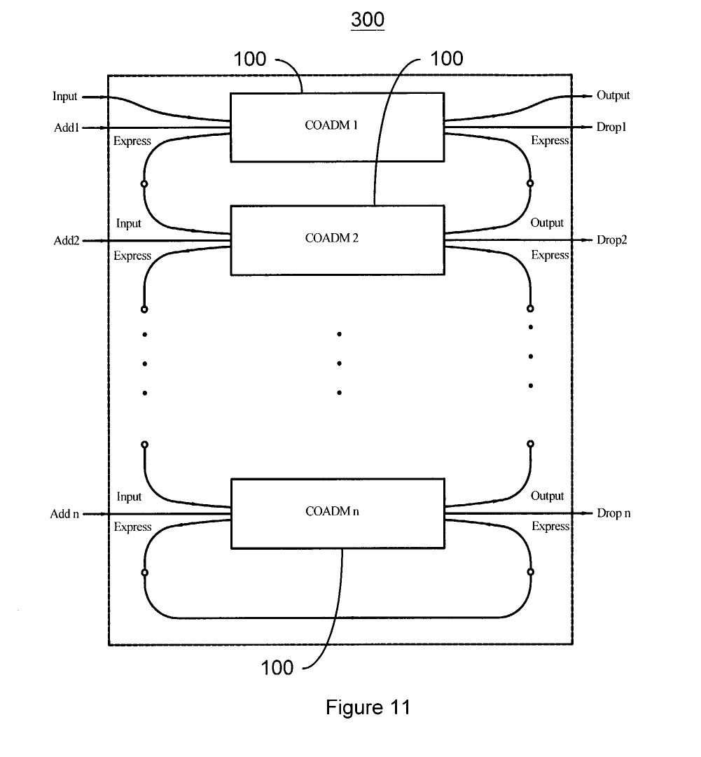

FIG. 11 depicts one embodiment of a multi-channel configurable optical add/drop module 300 in accordance with the present invention. The multi-channel optical add/drop module 300 includes multiple configurable optical add/drop modules 100. In the embodiment of the multi-channel optical add/drop module 300 shown, each configurable optical add/drop module 100 adds and drops a single channel. The input channel and output channel of each of the configurable optical add/drop modules 100 are connected to the express channels of the previous configurable optical add/drop module. The express channels of the last add/drop module 100 are coupled together. Thus, the multi-channel configurable optical add/drop module 300 can selectively add/drop or bypass (no add/drop) multiple individual channels from an optical signal. The total add/drop number of the configurable optical add/drop module 300 can be easily expanded by disconnecting the express channels of the last configurable optical add/drop module 100 and reconnecting them with the input channel and output channel of the additional configurable optical add/drop module 100.

A method and system has been disclosed for a configurable optical add/drop module that is stable, less expensive, compact in size and has a lower insertion loss. Although the present invention has been described in accordance with the embodiments shown, one of ordinary skill in the art will readily recognize that there could be variations to the embodiments and those variations would be within the spirit and scope of the present invention. Accordingly, many modifications may be made by one of ordinary skill in the art without departing from the spirit and scope of the appended claims.

What is claimed is:

1. A configurable optical add/drop module comprising:
a first filter for transmitting only a first set of wavelengths, the first filter for receiving an input signal and an add signal, the first filter for transmitting a portion of the input signal to a drop signal, for reflecting a remaining portion of the input signal to an express channel and for transmitting the add signal;
a second filter for transmitting only a second set of wavelengths, the second filter for reflecting the express channel to an output, for transmitting the drop signal and for transmitting the add signal; and
a beam deflector disposed between the first filter and the second filter, the beam deflector having a first position and a second position, in the first position the beam deflector transmits the drop signal and the add signal so that the second filter transmits the drop signal to a drop output and the add signal to the output, in the second position the beam deflector deflects the drop signal and the add signal so that the second filter transmits the drop signal to the output and decouples the add signal from the output.

2. The configurable optical add/drop module of claim 1 wherein in the first position, the beam deflector transmits the drop signal and the add signal undeflected.

3. The configurable optical add/drop module of claim 1 further comprising:
a first quadruple fiber pigtail including an input fiber for receiving the input signal, an add fiber for receiving the add signal, and an express channel fiber for transmitting the express channel.

4. The configurable optical add/drop module of claim 3 further wherein the first filter includes a first filter coating surface, the first filter coating surface facing the beam deflector, the configurable optical add/drop module further comprising:
a first focal lens disposed between the first quadruple fiber pigtail and the first filter, the first focal lens for collimating the add signal and the input signal to cross at the first filter coating surface.

5. The configurable optical add/drop module of claim 4 wherein the first focal lens is a cylindrical C-lens, a spherical or an aspherical lens.

6. The configurable optical add/drop module of claim 4 further comprising:
a second quadruple fiber pigtail including an output fiber for providing the output, a drop fiber for providing the drop signal to the drop output, and the express channel fiber for receiving the express channel.

7. The configurable optical add/drop module of claim 6 further wherein the second filter includes a second filter coating surface, the second filter coating surface facing the beam deflector, the configurable add/drop module further comprising:
a second focal lens disposed between the second quadruple fiber pigtail and the second filter, the second focal lens for collimating the express signal and focusing the add signal, the drop signal and the express signal reflected at the second filter coating surface to the output fiber and drop fiber.

8. The configurable optical add/drop module of claim 6 wherein the second focal lens is a cylindrical C-lens or a spherical lens or an aspherical lens.

9. A method for using a configurable optical add/drop module comprising the steps of:
(a) providing an input signal and an add signal to a first filter, the first filter for transmitting only a first set of wavelengths, the first filter for transmitting a portion of the input signal to a drop signal, for reflecting a remaining portion of the input signal to an express channel and for transmitting the add signal;
(b) providing the add signal and the drop signal to a beam deflector disposed between the first filter and a second filter, the beam deflector having a first position and a second position, in the first position the beam deflector transmits the drop signal and the add signal so that the second filter transmits the drop signal to a drop output and the add signal to an output, in the second position the beam deflector deflects the drop signal so that the second filter transmits the drop signal to the output and decouples the add signal from the output.
(c) providing the express channel, the drop signal and the input signal to the second filter, the second filter transmitting only a second set of wavelengths, the second filter for reflecting the express channel to the output, for transmitting either the drop signal or the add signal to the output based on the first position and the second position of the beam deflector.

10. The method of claim 9 wherein in the first position, the beam deflector transmits the drop signal and the add signal undeflected.

11. The method of claim 10 further comprising the steps of:
(d) providing the input signal and the add signal to a first quadruple fiber pigtail including an input fiber for receiving the input signal, an add fiber for receiving the add signal, and an express channel fiber for transmitting the express channel, the first filter residing between the first quadruple fiber pigtail and the beam deflector.

12. The method of claim 11 further wherein the first filter includes a first filter coating surface, the first filter coating surface facing the beam deflector, the method further comprising the step of:
(e) providing the drop signal and the add signal to a first focal lens disposed between the first quadruple fiber pigtail and the first filter, the first focal lens for collimating the add signal and the input signal to cross at the first filter coating surface.

13. The method of claim 12 wherein the first focal lens is a cylindrical C-lens, a spherical lens or an aspherical lens.

14. The method of claim 12 further comprising the step of:
(f) providing the express channel, the drop signal and the add signal to a second quadruple fiber pigtail including an output fiber for providing the output, a drop fiber for providing the drop signal to the drop output, and the express channel fiber for receiving the express channel.

15. The method of claim 14 further wherein the second filter includes a second filter coating surface, the second filter coating surface facing the beam deflector, the method further comprising the step of:
(g) providing the add signal and the drop signal to a second focal lens disposed between the second quadruple fiber pigtail and the second filter, the second focal lens for collimating the express signal and focusing the add signal, the drop signal and the express signal reflected at the second filter coating surface to the output fiber and drop fiber.

16. The method of claim 15 wherein the second focal lens is a cylindrical C-lens, a spherical lens or an aspherical lens.
